(19) United States
(12) Patent Application Publication
(10) Pub. No.: US 2026/0336179 A1
(43) Pub. Date: Oct. 29, 2026

(54) METHOD, DEVICE, AND COMPUTER PROGRAM FOR DETECTING AN ERROR IN THE ACTUAL POSITION OF AN AXLE OF A MACHINE

(71) Applicant: ARBURG GMBH + CO KG, Loßburg (DE)

(72) Inventor: Patrick SUHM, Gengenbach (DE)

(21) Appl. No.: 19/102,467

(22) PCT Filed: Aug. 2, 2023
(86) PCT No.: PCT/EP2023/071391

§ 371 Date: Feb. 10, 2025

(30) Foreign Application Priority Data
Aug. 12, 2022 (DE) 10 2022 120 407.3

(51) Int. Cl. B29C 45/76; G05B 19/406; G05B 23/02

(52) U.S. Cl. CPC B29C 45/768; G05B 19/406; G05B 23/0254; B29C 2945/76083; B29C 2945/76568; G05B 2219/45244

(57) ABSTRACT

The invention relates to a method for detecting an error in the actual position of an axle of a machine for handling and/or processing plastifiable materials. At least one model of the axle, comprising at least one model parameter, is provided, and at least one model input measurement variable of the axle and at least one model output measurement variable of the axle are detected. Furthermore, the model parameter of the model is estimated, and at least one expected measurement variable is simulated using the estimated model parameter of the model and the at least one model input measurement variable. The deviation of the at least one expected measurement variable from the at least one model output measurement variable is compared with at least one threshold, and if the threshold is exceeded, at least one action is carried out. Advantageously, a safe, efficient, and reliable method is thus provided for detecting an error.

### REFERENCE TO RELATED APPLICATIONS

The present application relates to and claims the priority of German patent application 10 2022 120 407.3, filed on Aug. 12, 2022, the disclosure of which is hereby expressly made the subject matter of the present application in its entirety.

### TECHNICAL FIELD

The disclosure relates to a method for detecting an error in the actual position of an axle of a machine for handling and/or processing plastifiable materials, in particular an injection moulding machine or a forming machine, an error detection device, and a computer program product.

The term “plastifiable material” as used in the present disclosure shall be understood broadly and includes in particular, but not exclusively, in addition to plastics or also silicone or other thermoplastic and/or elastomer materials, for example ceramic, metallic and/or powdered compounds as well as paper, cellulose, starch, cork, etc. and also mixed materials of such plastifiable materials. In principle, such materials may also be ones that have already been previously plasticised or also plastic compounds which, following application, cure automatically or with the use of auxiliary agents. The term also includes recyclates and compounds

### BACKGROUND

During and/or for operation of machines of all kinds, for example industrial machines, electric machines and/or forming machines, axles may be provided, for example plunging, positioning or linear axles, which perform various tasks. For example, in a machine for handling and/or processing plastifiable materials, in particular an injection moulding machine or a forming machine, in particular for handling injection moulded parts, one axle, for example a plunging, positioning or linear axle can be provided. For example, the finished moulded part can be removed from the injection mould using the axle. To drive the axle, a belt drive for example can be used here for a translatory movement of the axle in a direction. During operation of the machine and/or the drive as well as a movement of the axle, however, errors or deviations may occur, for example during movement of the axle, with a difference occurring between the target and the actual position, for example in the form of a tracking error. Likewise an error, or in the worst-case scenario a failure of the drive and thus failure of the machine as a whole, may occur due to an overload.

Methods are known in the prior art for monitoring tracking errors, as well as methods for detecting an overload.

Document DE 10 2008 045 330 A1 describes a method for the dynamic detection of faulty operation of a load lifting device, wherein a signal that is proportional to a force exerted by the load receiving means is monitored by means of a force sensor. If an increase in the signal is detected, it is checked whether a nominal overload threshold has been exceeded and a corresponding switch-off signal is generated.

Document US 2018/0210436 A1 discloses a method and a system for process monitoring of an industrial process, wherein an integrated digital twin of the facility is provided, which is implemented by a computer system. An aggregation algorithm utilises models including a plurality of inter-related static models for the industrial facility including an asset model that describes devices and systems in the industrial facility including sensors coupled to processing equipment and a flowsheet model, and dynamic models of the industrial facility. The aggregation algorithm, using outputs from the static models and dynamic model, generates an aggregated view including performance alerts for at least one of the process equipment and the industrial process based on a current performance of the industrial process.

Document EP 3 617 826 A1 discloses a management monitoring method with real-time detection devices and sensors for detecting the state of a target device and of a command which is output by a central control device which inputs a control command into the target device, and a management monitoring device for detecting information from the real-time detection devices. The management monitoring device comprises an analysis unit for simulating the state of the device in question using models of the device in question and of the central control device. An assessment unit for comparing the result calculated by the analysis unit with the information detected by the real-time detection devices and for assessing whether a malfunction has occurred device in question is furthermore provided.

Document EP 3 667 446 A1 discloses an error diagnostic system comprising an instrument, for example a sensor, which is configured such that it performs a measurement of a measured value in relation to the behaviour of a diagnosis target, and comprising an error diagnostic device which comprises a model of the diagnosis target and is configured such that it performs a simulation on the basis of the model. The error diagnostic device is configured such that it offers a suggestion to a user to measure a new parameter in respect of the diagnosis target on the condition that a difference between a result of the simulation and the measured value is greater than a predetermined error range, but the difference fails to provide an adequate basis for determining whether or not the diagnosis target has an error.

Document EP 3 540 546 A1 discloses a device for supporting the prediction of an error, a method for supporting the prediction of an error, and a program for supporting the prediction of an error, by which a user can easily detect an anomaly in time series data in relation to an item of equipment. The error prediction support device comprises a difference detection part, which takes into consideration actual machine time series data, relating to the control of a device, and simulation time series data, relating to the control of the simulated device, and detects a difference between the actual machine time series data and the simulation time series data.

A disadvantage of the method used in the prior art is that various errors, such as a broken belt, bearing damage or loose attachments, are only detected indirectly, very late or not at all.

### BRIEF SUMMARY

The disclosure addresses the problem of providing an advantageously safe, efficient and reliable method for detecting an error in the actual position of an axle of a machine for handling and/or processing plastifiable materials, in particular an injection moulding machine or a forming machine.

The idea of the method according to the disclosure is to use a dynamic model of the drive train of the axle to validate the measured drive values.

The method for detecting an error in the actual position of an axle, such as an electric, hydraulic, pneumatic axle, a plunging, positioning and/or linear axle of a machine for handling and/or processing plastifiable materials, in particular an injection moulding machine or a shaping machine, comprises the following steps.

Firstly, at least one model of the axle, preferably a dynamic model of the axle, comprising at least one model parameter is provided. For example, a model of the drive train can be provided for the axle.

In mathematics, for example, a model parameter is a variable of a mathematical model that occurs together with other variables in the model but is of a different quality. A model parameter is also referred to as being arbitrary but fixed. It therefore differs from a model constant in that the model parameter is only constant for the case currently under consideration, but can vary for the next case.

The model parameter comprises parameters that are linked to the model and describe the model in greater detail. The model parameter can, for example, be a scalar, a vector or a tensor with various parameters. For example, the model parameter can include a moment of inertia, damping, e.g. viscous damping or a constant disturbance, such as gravity. In principle, however, other model parameters are also possible depending on the model used.

The model can have various formulas, relationships, equations and/or parameters. Furthermore, the model can have at least one parameter, a model input and/or a model output. For example, the model can have three parameters, a model input, e.g. a vector model input and a model output, e.g. a scalar model output.

At least one model input measurement variable, e.g. an angle, an angular acceleration and/or an angular velocity, and at least one model output measurement variable of the axle, in each case for example a rotational speed, a torque, a motor torque, an angular velocity, a power consumption, a current and/or a pressure, are detected. The at least one model input measurement variable is detected for the model input of the model and the at least one model output measurement variable is detected for the model output of the model. In principle, these can each be the same measurement variable, e.g. the angle or the angular velocity, wherein the measurement variables preferably differ from one another. The detection can be carried out, for example, using corresponding sensors or a corresponding sensor system on the axle and/or the machine. The at least one model input measurement variable and/or model output measurement variable can be represented and/or used in various ways, e.g. as a scalar, a vector or a tensor. For example, the model input measurement variable can be represented and/or used as a measurement vector, which has, for example, the angular velocity and/or the derivative of the angular velocity, and the model output measurement variable can be represented and/or used as a scalar, for example the motor torque.

Furthermore, at least one estimation is made of the at least one model parameter of the at least one model. The estimation is used to perform an approximate determination of the model parameter. The estimation can preferably be carried out using statistical-mathematical methods, such as a “least squares” method. The model parameter is thus estimated in such a way that the quadratic error between the model output and the model output measurement variable is minimised. For example, formula 5 shown later describes a least squares method, with formula 6 indicating an analytical solution of formula 5, and formula 7 in turn indicating a recursive form of formula 6. The estimation of the at least one model parameter in this figure corresponds to an application of formula 7 or formula 8. In formula 7, the model parameter is estimated or adjusted, e.g. recursively, and updated accordingly. Furthermore, the estimation or adjustment can preferably be time-dependent, e.g. in each cycle of the machine control, so that the model parameter changes and is updated accordingly. For example, the model parameter can be initialised with zero when the machine is started and adjusted by the machine control system in a specific time interval, e.g. in a low millisecond cycle, using formula 7 shown later. This has the advantage of compensating for wear and/or ageing phenomena, ensuring the robustness required in an industrial environment and avoiding false triggering. Preferably, the at least one model input measurement variable and/or the at least one model output measurement variable is used to estimate the at least one model parameter. If, for example, an angular velocity, an angular acceleration and a torque are used for the estimation, the resulting model parameters are, for example, a moment of inertia, a damping and/or a disturbance torque. Formula 5, 6, 7 and/or 8 is also preferably used for the estimation.

By means of the at least one estimated model parameter of the model and the detected at least one model input measurement variable, e.g. the angle, the angular velocity and/or the angular acceleration, at least one expected measurement variable, e.g. an expected torque, is simulated. For example, formula 1 shown later can describe the simulation of the expected measurement variable.

This is followed by a comparison of the deviation of the at least one expected measurement variable from the detected at least one model output measurement variable with at least one threshold value. In principle, however, the expected measurement variable could also be compared directly with the (detected) model output measurement variable. Compared to pure overload or acceleration monitoring, for example, this has the advantage that the actual torque and the simulated torque, for example, behave in opposite directions in the event of a collision, e.g. an axle collision, which allows earlier detection with the same threshold value compared to other methods. Acceleration or jolt monitoring also has the disadvantage that collisions with less rigid objects are not recognised.

If the threshold value is exceeded, at least one action is carried out, e.g. a warning signal can be output, a control signal for the machine can be generated and/or the machine can be transferred to a safe state.

Preferably, the at least one model input measurement variable differs from the at least one model output measurement variable. It is therefore preferable for at least one measurement variable to be detected as the model input measurement variable and at least one further measurement variable to be detected as the model output measurement variable. For example, the model input measurement variable can be an angle, an angular velocity and/or an angular acceleration and the model output measurement variable can be a motor torque. For example, to simulate the at least one expected measurement variable, the model input measurement variable, e.g. the angle, the angular velocity and/or the angular acceleration of the axle, is detected and the model output measurement variable, e.g. the motor torque, the current or the power consumption of the axle, is detected to compare the deviation of the expected measurement variable with the threshold value. This provides the advantage of reliable, precise and robust error detection.

The method can also be used advantageously to detect structural changes. For example, a crack in a belt can be detected at an early stage. In the case of axles that are driven by a belt, the belt stiffness is normally negligibly high. This means, for example, that it may be permissible to set up the model in such a way that no distinction is made between motor inertia and axle inertia. A significant reduction in the belt stiffness, for example by wear, means that the model no longer matches the real system, as there is now an additional or non-modelled degree of freedom. As a result, the real torque curve can no longer be modelled, for example, and error detection is triggered. It is also advantageously possible for bearing damage to be recognised, as the torque curve, for example, cannot be mapped with the applied model above a certain severity of damage. It is also advantageous to recognise axle parts that become detached from the rest of the axle due to vibrations. As electrical anomalies such as short circuits or component effects, for example, are also reflected in the measured torque value of the machine, this can also be advantageously recognised by the method.

The method can also be used for various axles, for example hydraulic and/or pneumatic axles, which are driven by a cylinder, for example. One measurement variable could be the cylinder pressure, preferably multiplied by the piston area. If the detected pressure does not match the simulated pressure, there is an anomaly.

At least one signal portion of the at least one model input measurement variable and/or the at least one model output measurement variable is preferably detected for quick and easy detection of the at least one model input measurement variable and/or the at least one model output measurement variable. For example, the speed, the torque, the motor torque, the power consumption, the current or the pressure can be detected as a signal portion, for example, over time or location by means of corresponding sensors. Advantageously, the derivative of the at least one model input measurement variable and/or model output measurement variable can be formed by means of the difference quotient.

Preferably, at least one mathematical operation, for example a differentiation, a derivation and/or an integration, is used to generate at least one other signal portion of the at least one model input measurement variable and/or model output measurement variable. For example, the angular velocity can be detected as the model input measurement variable and a corresponding acceleration can be obtained by deriving the angular velocity over time. This results in more accurate error detection, as several variables are included in the error detection.

For an advantageous compensation of wear and/or ageing phenomena, at least one adjustment of the at least one model and/or the at least one model parameter is preferred. This also advantageously ensures the robustness required in an industrial environment and avoids false triggering. For example, the adjustment can be carried out using formula 7 shown later. In formula 7, the model parameter is adjusted, e.g. recursively, and updated accordingly. Furthermore, the adjustment can preferably be time-dependent, e.g. in each cycle of the machine control system, so that the model parameter changes and is updated accordingly. For example, the model parameter can be initialised with zero when the machine is started and adjusted by the machine control system in a specific time interval, e.g. in a low millisecond cycle, using formula 7 shown later.

Preferably, the at least one model is linearly dependent on the at least one model parameter. Advantageously, the linear dependence makes it possible to set up a convex optimisation problem for estimating the model parameter. Further preferably, linearity is only required with respect to the model parameter. This means that non-linear effects can also be modelled advantageously. An example would be a rotational axle that is orthogonal to the gravity vector and the loading of which is not symmetrical to the axis of rotation. In the static case, such an axle can apply a torque that is non-linearly dependent on the angle of rotation. In this case, a measurement vector may look like this, for example: x=[ω′, ω, sin(φ), 1]^{T}, wherein ω is the angular velocity of the axle and φ is the angle of the axle. The measurement vector can be used for the model input, for example.

For an advantageous increase in safety and simple and fast tracking of an error, at least one diagnostic file is preferably generated when the at least one threshold value is exceeded, and includes, for example, the time curves of the measurement variables, the signal portions and/or the parameters. The diagnostic file can also include further information relating to the machine or the error that has occurred and can be made available directly on the machine or in a network, for example.

For an advantageously safe and reliable estimation of the at least one model parameter, at least one instance of a critical axle speed of the axle being exceeded is preferably checked.

Preferably the estimation of the at least one model parameter is only activated when the critical axle speed of the axle is exceeded. Below this speed, it is difficult to make a reliable estimation with the model used, as non-linearities such as cogging force, friction or low-frequency vibrations are dominant. For example, if the axle moves too slowly, the estimation cannot be carried out. In principle, however, error detection can still be active.

In order to favourably avoid false triggering and/or non-triggering of the error detection, at least one model certainty of the at least one model of the axle is preferably checked. For example, the model certainty can be described by means of at least one uncertainty parameter. During the check, for example, a value of the uncertainty parameter can be checked. If the value of the uncertainty parameter is zero or substantially zero, for example, sufficient model certainty is guaranteed. If model certainty is not guaranteed, false triggers and/or non-triggers may occur, as the model would then not represent the processes with sufficient accuracy. Preferably, the at least one model certainty is checked by determining the eigenvalues of a covariance matrix. This advantageously produces more accurate and precise results.

It is also preferred that error detection is only activated from a certain model certainty. The model certainty indicates how well the model predicts the model output measurement variable. It can be determined, for example, by calculating the eigenvalues of the covariance matrix. The smaller an eigenvalue of the covariance matrix, the greater the certainty of the associated model parameter. The model certainty can also be described using an uncertainty parameter or the eigenvalue. For example, error detection is only activated below one per cent uncertainty or if the uncertainty parameter is substantially zero.

Preferably, the covariance matrix can be initialised at first as a diagonal matrix with maximum eigenvalues and/or adjusted in at least one time step, e.g. a control cycle. This has the advantage of providing reliable model certainty with a manageable computational effort. For example, the covariance matrix can initially be initialised as a diagonal matrix with large maximum eigenvalues, e.g. over 100, and/or adjusted in at least one time step. Large eigenvalues lead to strong parameter corrections, which are also desirable at first if the parameters are initialised with zero. For example, the model can be released for estimation as soon as all eigenvalues of the covariance matrix are below one per cent of their maximum value, e.g. of 100.

It is preferable to check whether the estimation of the at least one model parameter was active for at least one critical time. This has the advantage of reducing the uncertainty of the model, which leads to reliable error detection. The critical time indicates the time required to ensure sufficient model certainty. For example, a critical time can be a period of 200 ms.

Preferably the error detection function is only activated once the estimation of the model parameter has been active for at least the critical time. For example, the error detection can be activated from an estimate of the model parameter for at least a period of 200 ms.

In order to react favourably to changes, for example in the drive train of the axle, the model and/or the at least one model parameter is preferably adjusted to at least one ambient condition, more preferably to at least one new ambient condition. Once the model structure has been defined, the model output can be influenced with a given model input, e.g. by changing the model parameters. The model can thus be adjusted to the environment by adjusting the model parameters to the environment. This is an advantageous way of compensating for a change in operating point, disturbances or invariances of the system to be modelled and/or the axle.

For an advantageously reliable error detection, the adjustment of the model and/or the adjustment of the at least one model parameter preferably takes place more slowly than the error detection. In this way, false triggering and/or non-triggering can be advantageously avoided. For example, the model adjustment can take place at least one order of magnitude or at least one power of ten slower than the error detection. If model adjustment were to take place faster or significantly faster than error detection, it would not be possible, for example, to recognise slow phenomena such as bearing damage.

For an estimation of the at least one model parameter that is advantageously as simple and fast as possible, the estimation of the at least one model parameter is preferably performed recursively and/or a recursive least squares algorithm is used for the estimation of the at least one model parameter. Further advantageously, it is therefore not necessary to store the measurement data in a memory, and a time delay due to the filling of a measurement matrix and an output vector is avoided. In addition, the recursive estimation is advantageous in that no matrix inversion is required.

In principle, however, a non-recursive estimation of the model parameter is also possible.

Preferably, the at least one model input measurement variable and/or the at least one model output measurement variable is used to estimate the at least one model parameter. This advantageously results in an accurate and precise model parameter. If, for example, an angle, an angular velocity and/or an angular acceleration is used as the model input measurement variable and a torque, for example, is used as the model output measurement variable, the resulting model parameters are, for example, a moment of inertia, a damping and/or a disturbance torque.

The disclosure provides also an error detection device which is set up, configured and/or constructed for simple, efficient and reliable error detection in order to carry out the method described above.

The disclosure provides also a computer program product. For simple, efficient and reliable error detection, the computer program product is provided with a program code, which is stored on a computer-readable medium, for carrying out the method described above.

Further advantages can be found in the dependent claims and the following description of a preferred exemplary embodiment. The features listed individually in the claims can be combined with one another in a technically feasible way and can be supplemented by explanatory facts from the description and by details from the Figures, wherein further variants of the disclosure are shown.

### BRIEF DESCRIPTION OF THE FIGURES

In the following, the disclosure is explained in greater detail with reference to an exemplary embodiment shown in the attached figures, in which:

FIG. 1 shows a schematic representation of a machine with an axle,

FIG. 2 shows a block diagram,

FIG. 3a shows a model in normal operation,

FIG. 3b shows a model with an anomaly,

FIG. 4a shows an estimated and measured torque curve in normal operation,

FIG. 4b shows an estimated and measured torque curve in the anomaly case,

FIGS. 5a-5c show a transient behaviour of the model parameters,

FIG. 6 shows a flow chart, and

FIG. 7 shows a block diagram.

### DETAILED DESCRIPTION

The disclosure will now be explained in greater detail by way of example with reference to the accompanying drawings. However, the exemplary embodiments are only examples and are not intended to limit the inventive concept to a particular arrangement. Before the disclosure is described in detail, it should be pointed out that it is not limited to the respective components of the device and the respective method steps, as these components and methods may vary. The terms used herein are merely intended to describe particular embodiments and are not used in a limiting manner. Furthermore, when the singular or indefinite articles are used in the description or in the claims, this also refers to the majority of these elements, unless the overall context clearly indicates otherwise.

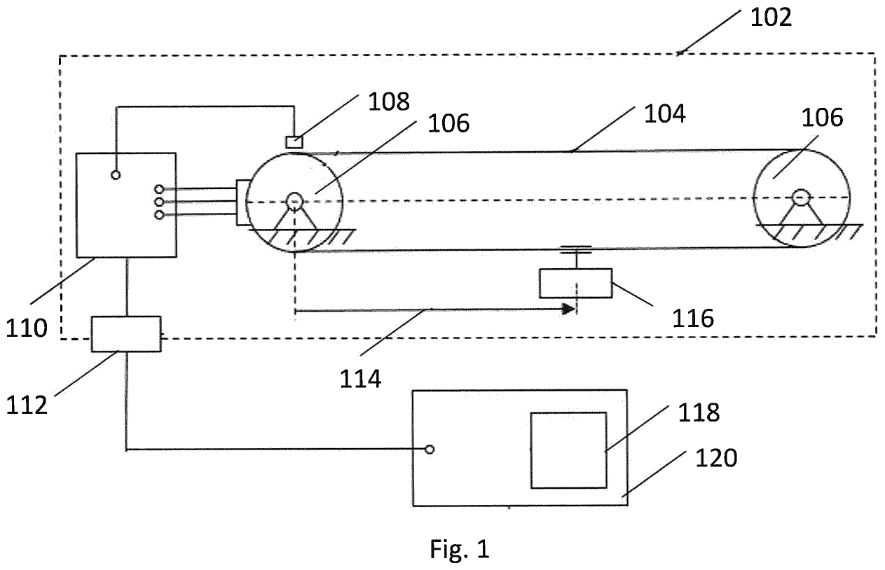

FIG. 1 schematically illustrates a machine 102 for handling and/or processing plastifiable materials, in particular an injection moulding machine or a forming machine, with an axle 116, for example a linear axle 116. In principle, the axle can be, for example, an electric, hydraulic, pneumatic axle, a plunging, positioning and/or linear axle. The machine 102 has a belt 104 and deflection pulleys 106, with which a translatory movement of the axle 116 along a direction 114 can be performed. The belt drive can be controlled by means of a drive control system 110, wherein a detection unit 108 detects at least one measurement variable of the axle 116 and communicates to a communication interface 112. In FIG. 1, the machine 102 may be controlled by a machine control system 120 having a data memory 118.

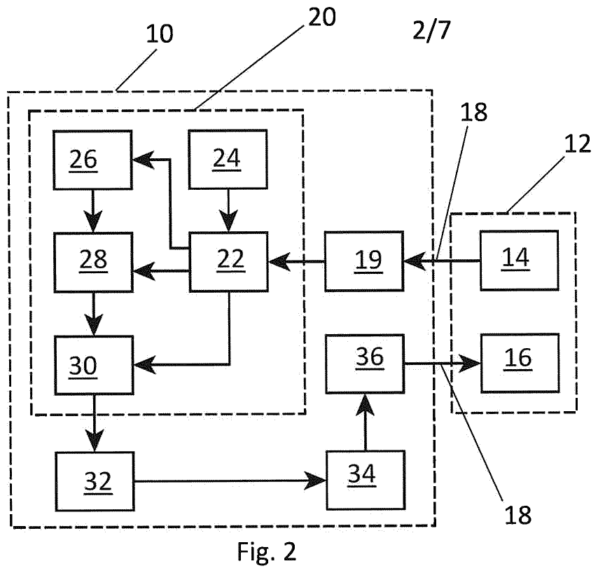

FIG. 2 shows a block diagram of an exemplary embodiment of the method. In a block model structure 24, at least one model of an axle 12 with at least one model parameter is provided, wherein the model parameter can be represented, for example, as a vector comprising as parameters moment of inertia, viscous damping and constant disturbance torques, for example gravity. The model parameter can also be represented as a scalar or a tensor with various parameters. At least one model input measurement variable and at least one model output measurement variable of the axle 12 are detected by means of a sensor system 14. This can be, for example, a rotational speed, a torque, a motor torque, a pressure, a power consumption, a current, an angle, an angular acceleration and/or an angular velocity. The at least one model input measurement variable can be detected for a model input of the model and the at least one model output measurement variable can be detected for a model output of the model.

The detected at least one model input measurement variable and at least one model output measurement variable are transmitted by means of a bus 18, for example a field bus, to a signal detection 19 of a machine control system 10.

In a further preferred exemplary embodiment, the at least one model input measurement variable and the at least one model output measurement variable differ from one another. In this preferred exemplary embodiment, at least two different measurement variables are therefore detected with the sensor system 14. For example, a rotational speed, a torque, a motor torque, a power consumption, a current, a pressure and/or an angular velocity can each be detected. For example, the model input measurement variable can be an angle, an angular acceleration and/or an angular velocity and the model output measurement variable can be a motor torque. In principle, however, the measurement variables and/or the model input and model output measurement variables can also represent the same measurement variables, e.g. the angular velocity or the motor torque.

The detection of the at least one model input measurement variable and the at least one model output measurement variable can comprise the detection of at least one signal portion of the at least one model input measurement variable and/or the at least one model output measurement variable. For example, the angular velocity can be detected in a specific time interval or during a specific period of time. It is also possible to detect it as a function of a cycle property, e.g. a distance or a time, so that a signal curve is produced over the distance or time within which the signal portion is provided.

Furthermore, additional signal portions of the at least one model input measurement variable and/or the at least one model output measurement variable can be generated in the signal detection 19, for example by at least one mathematical operation. For example, the angular velocity of the axle 12 can be detected with the sensor system 14 and the acceleration of the angular velocity can be generated in the signal detection 19 by differentiating the angular velocity with respect to time in a signal portion.

In a model-based axle monitoring system 20, the measured and/or generated measurement variables can be summarised in a model generation 22, for example to form a measurement vector, a measurement scalar or a measurement tensor. For example, the angular velocity and its time derivative can be summarised as a measurement vector and the motor torque can be described as a measurement scalar. For example, the measurement vector can be used as a model input measurement variable for the model input and the measurement scalar as a model output measurement variable for the model output.

With a parameter estimation 26, the model parameter of the model is estimated or adjusted and in a simulation 28 at least one expected measurement variable, e.g. an expected motor torque, is simulated by means of the estimated model parameter of the model and the measurement variable. If, for example, an angular velocity and/or an angular acceleration are used as model input measurement variables in the parameter estimation 26 and a motor torque is used as model output measurement variable, the resulting model parameters are, for example, a moment of inertia, a damping and/or a disturbance torque. The model parameters can be used in the simulation 28 to simulate at least one expected measurement variable, e.g. a simulated torque. The simulated torque can then be compared with the model output measurement variable motor torque. The estimation or adjustment can preferably take place in a certain time interval, for example during operation of the machine 102, e.g. in each cycle of the machine control system. The model parameter is adjusted accordingly and changes. In a check 30, the deviation of the at least one expected measurement variable, e.g. the expected motor torque, from the at least one model output measurement variable, e.g. the detected motor torque, is compared with at least one threshold value. For example, the model input measurement variable, e.g. the angular velocity and/or the angular acceleration of the axle, can be used to simulate the at least one expected measurement variable, and the model output measurement variable, e.g. the motor torque of the axle, can be used to compare the deviation of the expected measurement variable with the threshold value. This results in reliable, precise and robust error detection.

In principle, however, the expected measurement variable can also be compared directly with the (detected) model output measurement variable. For example, the expected motor torque could be compared with the detected motor torque. If the check 30 shows that the threshold value has been exceeded, at least one action can be carried out, for example at least one diagnostic file can be generated and/or at least one alarm message 32 can be generated, which outputs a signal by means of an alarm handler 34 to a control signal generator 36 of the machine control system 10, which in turn actuates an actuator 16 of the axle 12 by means of the bus 18. In this way, for example, the axle 12 can be transferred to a safe state.

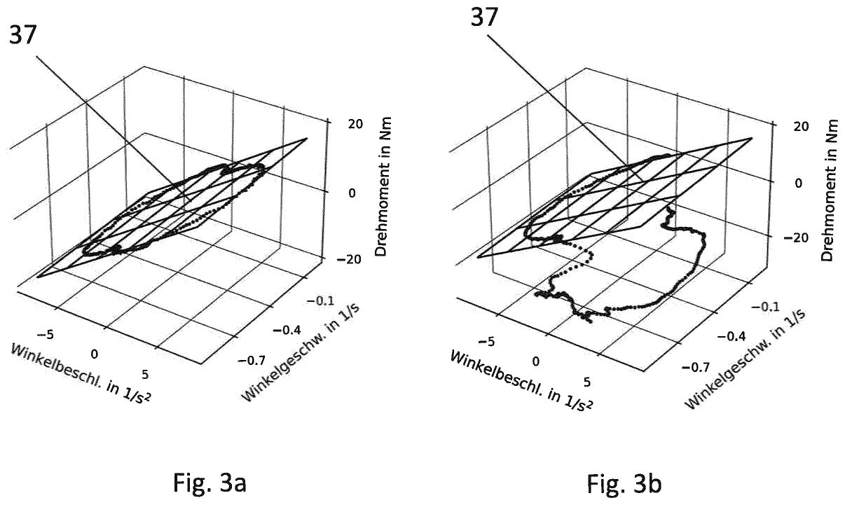

In FIG. 3a and FIG. 3b, the model is shown, for example, in the form of a plane 37. The measurement variables detected and/or generated in FIGS. 3a and 3b are the angular velocity, its derivative or acceleration, and the motor torque. If, for example, the measured values of the detected torque lie within the plane 37, the drive of the axle is running in normal operation (FIG. 3a). If the values leave the plane 37, this indicates an error in the drive train, for example.

In a further preferred exemplary embodiment, at least one adjustment of the model parameter can take place. The adjustment can preferably take place at a certain time interval, for example during operation of the machine 102, e.g. in each cycle of the machine control system. The model parameter is adjusted accordingly and changes. This means that the position and orientation of the plane from FIGS. 3a and 3b can change over time. Advantageously, the model can thus be adjusted quickly and easily.

In another preferred exemplary embodiment, the model parameter is initialised to zero, for example when the machine 102 is started.

In a further preferred exemplary embodiment, the model can depend linearly on the model parameter p and/or have three parameters and a scalar output:

y=p^{T}x (formula 1)

x=[ω′, ω, 1]^{T} (formula 2)

p=[j, d, q]^{T} (formula 3)

\tilde{y}=T (formula 4)

For example, x in this case denotes the measurement vector, ω the angular velocity of the drive, ω′ the derivative of the angular velocity or the acceleration, j the moment of inertia, d the viscous damping, q the constant disturbance torques (e.g. gravity), y the model output, \tilde{y} the measured output variable and T the (detected) motor torque. The parameters (j, d, q) form the model parameter p, e.g. a vector. The use of the model parameter p can be determined by formula 1, for example.

The linear parameter dependency advantageously makes it possible to set up a convex optimisation problem to estimate the drive parameters:

minₚ∥y−Xp∥², p∈R^{m}, y∈Rⁿ, X∈R^{n×m} (formula 5)

Here, m indicates the number of parameters and n the number of measurement samples. The rows of the measurement matrix X consist of the measurement vectors x of the time steps k∈[1, . . . , n], the vector y contains the measured output variables, e.g. \tilde{y} for the time steps k∈[1, . . . , n].

The analytical solution for formula 5 is:

\hat{ }p=(X^{T}X)⁻X^{T}y (formula 6)

In order to recognise an anomaly, a model output y=\hat{ }p^{T}x can be simulated using the estimated model parameter \hat{ }p and the current measurement data x. The deviation |y−\tilde{y}| can then be compared with a threshold value. If the threshold value is exceeded, the error detection is triggered.

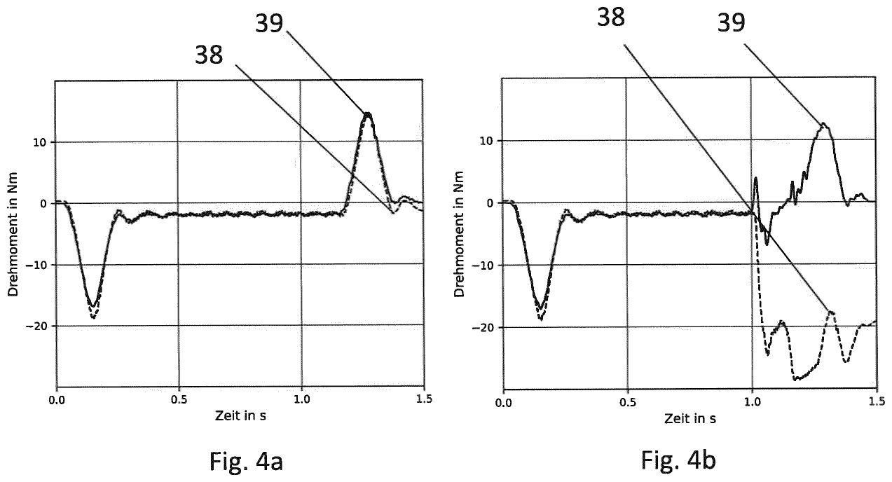

FIGS. 4a and 4b show the estimated torque curve 39 and the detected torque curve 38 over time for normal operation (FIG. 4a) and the anomaly case (FIG. 4b). For the anomaly case, a clear deviation between the estimated and detected curve can be recognised even after a very short time.

In a further preferred exemplary embodiment, the estimation of the model parameter can be recursive and/or a recursive least squares algorithm can be used for the estimation of the model parameter.

The recursive formulation for the estimated model parameter or of equation 6 allows the model parameter to be adjusted, e.g. in a control cycle, advantageously without time delay:

\hat{ }pₖ₊₁=\hat{ }pₖ+(Cₖxₖ₊₁/(λ+xₖ₊₁^{T}Cₖxₖ₊₁)) (yₖ₊₁−xₖ₊₁\hat{ }pₖ) (formula 7)

with λ+xₖ₊₁^{T}Cₖxₖ₊₁=Γₖ

Cₖ₊₁=1/λ(Cₖ−Γₖxₖ₊₁^{T}Cₖ) (formula 8)

If, for example, the axle 12 is above a certain speed, the model parameter p can be constantly adjusted using formula 7 so that the parameters j, d, q are constantly more accurate. The parameters j, d, q or the model parameter p is thus adjusted to the ambient conditions.

In principle, the model parameter can be adjusted using both formula 6 and formula 7. Formula 7 describes a preferred recursive formulation of formula 6. The difference between formula 6 and 7 is that a measurement matrix X is used for formula 6, whereas a measurement vector x can be processed with formula 7. To apply formula 6, measurement vectors x of the axle 12 can be detected over a certain period of time, e.g. a few seconds, and stored in the measurement matrix X. The model parameter can then be calculated on the basis of this measurement matrix X. Formula 7, on the other hand, advantageously allows the model parameters to be adjusted preferably in every control cycle, e.g. every two milliseconds, on the basis of the current measurement vector x, and does not require intermediate storage of the measurement data.

Here, C denotes the covariance matrix and λ the forgetting factor. The eigenvalues of the covariance matrix contain information on the uncertainty of the parameters.

In a preferred exemplary embodiment, the model can be adjusted to at least one new ambient condition. Furthermore, λ can be used to set how quickly the model adjusts to new ambient conditions. For example, λ, which can assume typical values between 0.9 and 1, can be used to set how quickly the model adjusts to new ambient conditions. The smaller λ is selected, the greater the extent to which current measurement variables, which are more recent or have only recently been detected, are taken into account in the adjustment of the model parameter.

In a further preferred exemplary embodiment according to FIG. 2, for example, at least one model can initially be provided in the model structure 24, for example a dynamic model of the drive train according to formulas 1-4. The model-based axle monitoring 20 detects at least one measurement variable of the axle 12 by means of the sensor system 14. For example, the angular velocity and the motor torque can be detected, wherein the angular velocity and its time derivative are stored in a measurement vector x (formula 2) and the motor torque is stored as a measured output variable y (formula 4). The model parameter is estimated using the condition in formula 5 and formula 7. Formula 6 describes a solution to formula 5, while formula 7 represents a recursive solution.

In the next step, the model parameter can be adjusted using the measurement vector x and the output variabley by means of formulas 7 and 8. A simulation y=\hat{ }p^{T}x (formula 1) is then carried out with the adjusted model parameter and the current measurement vector x to obtain an expected measurement variable, e.g. an expected motor torque. The simulated expected measurement variable, e.g. the expected motor torque, is then compared with the detected output variable y, the detected motor torque. If the two values deviate too far from each other, at least one action is taken, e.g. a warning signal is output, an alarm is triggered, a control signal is generated for the machine and/or the axle is transferred to a safe state.

In a further preferred exemplary embodiment, the measurement vector x is not filled with measured values for the simulation, but with target values. This results, for example, in a target torque based on a target speed and a target acceleration. Actual values in the measurement vector x are still used to estimate the model parameter.

In a further preferred exemplary embodiment, the adjustment of the model and/or the adjustment of the at least one model parameter takes place more slowly than the error detection, for example by at least one order of magnitude or by at least one power of ten.

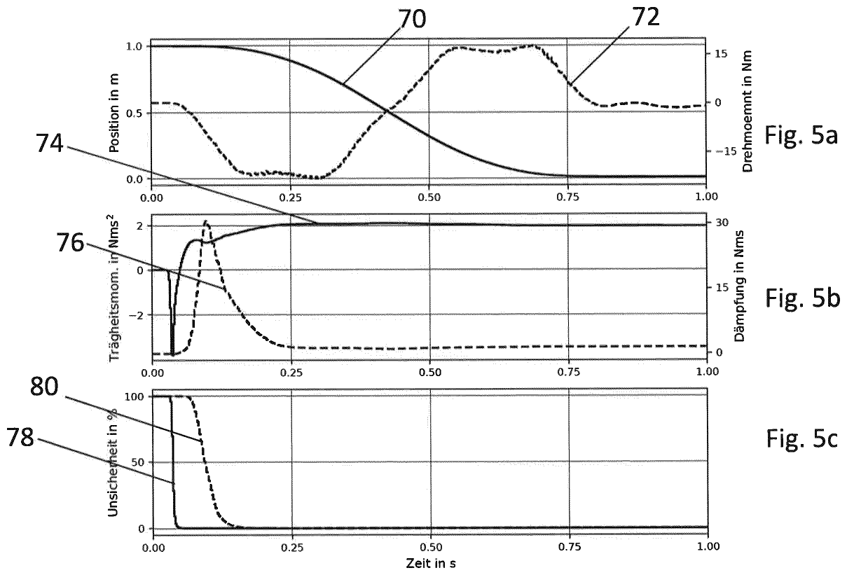

In another preferred exemplary embodiment, the error detection is only activated from a certain level of model certainty in order to avoid false triggering. FIGS. 5a-c show the transient behaviour of the model parameter when the axle performs a positioning process (FIG. 5a) and the model parameter was previously initialised with zero. In FIG. 5a, the position 70 and the torque 72 and in FIG. 5b the inertia 74 and the damping 76 are plotted against time. FIG. 5c shows the uncertainties 78 and 80 with regard to the inertia and damping over time. For example, the uncertainty in the parameters of the moment of inertia and damping (FIG. 5b) already disappears after 200 ms (FIG. 5c) in this positioning process, as the system is excited by a sufficient number of frequencies.

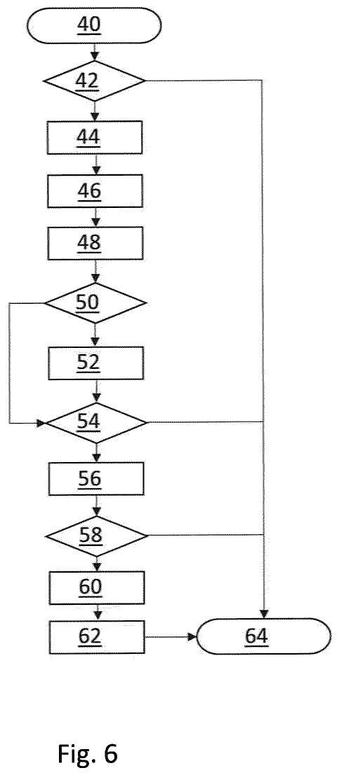

FIG. 6 shows a flow chart of another preferred embodiment.

After a start 40, an optional step 42 can be provided, in which it is first checked whether the error detection is active. If this is not the case, the method comes to an end 64.

If the error detection is active, at least one model of the axle with at least one model parameter is provided in a step 44, wherein the model parameter can include, for example, the moment of inertia, the viscous damping or constant disturbance torques, such as gravity.

In a step 46, at least one model input measurement variable of the axle and at least one model output measurement variable of the axle, for example a rotational speed, a torque, a motor torque, a power consumption, a current, an angle, an angular acceleration, an angular velocity and/or a pressure is detected.

In a further preferred exemplary embodiment, at least one signal portion of the at least one model input measurement variable and/or model output measurement variable can be detected in a step 48. In the step 48, in a further preferred exemplary embodiment, at least one other signal portion of the at least one model input measurement variable and/or model output measurement variable can also be generated by at least one mathematical operation, for example by a differentiation, a derivation and/or an integration.

Furthermore, in a further preferred exemplary embodiment, it is possible to check in a step 50 whether a critical axle speed of the axle is exceeded. If the critical axle speed is not exceeded, the at least one model parameter is preferably not estimated according to a step 52.

If the critical axle speed is exceeded, the at least one model parameter is estimated in a further preferred exemplary embodiment according to step 52, for example using formulas 5-8.

In a further step 54, in a further preferred exemplary embodiment, at least one model certainty of the at least one model of the axle can be checked. For example, the model certainty can be represented by means of an uncertainty parameter which, for example, must assume or exceed a certain value. In addition, it can be checked in step 54 whether the estimation of the model parameter has already been active for a critical time, e.g. for a period of 200 ms. If the model certainty is not sufficient, the method comes to the end 64.

If the model certainty is sufficient, e.g. if the uncertainty is small enough and the estimation of the model parameter was active long enough, at least one simulation of at least one expected measurement variable is performed in a step 56 using the estimated model parameter of the model and the model input measurement variable, for example using formula 1.

In a step 58, the deviation of the expected measurement variable from the model output measurement variable is compared with at least one threshold value. If the threshold value is not exceeded, for example, the method comes to an end 64.

If the threshold value is exceeded, for example, at least one action is carried out in a further preferred exemplary embodiment in a step 60, e.g. at least one control signal is generated for the machine, wherein the axle of the machine can be transferred to a safe position by the control signal.

In a further preferred exemplary embodiment, at least one diagnostic file can be generated in a step 62. The diagnostic file may, for example, comprise the temporal curves of the measurement variables, the signal portions and/or the parameters. The diagnostic file can also comprise further information relating to the machine or the error that has occurred and can, for example, be made available directly on the machine or in a network.

In a further preferred exemplary embodiment, the at least one model certainty is checked on the basis of the determination of the eigenvalues of a covariance matrix.

In a further preferred exemplary embodiment, the at least one model input measurement variable and/or the at least one model output measurement variable is used for the estimation of the at least one model parameter.

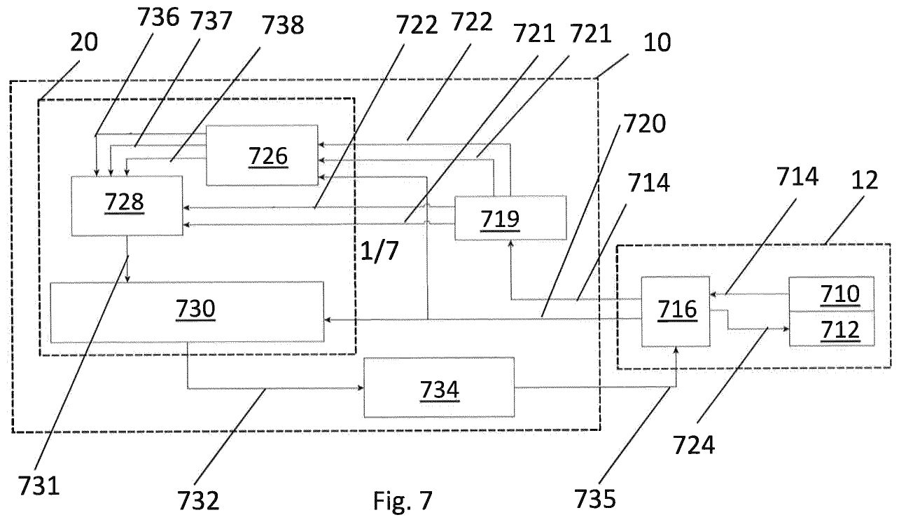

In a further preferred exemplary embodiment according to FIG. 7, a block diagram is shown. There, the axle 12 has an electric motor 712 and an inverter 716 as well as an angle sensor 710. In principle, the axle 12 can comprise further elements and sensors, e.g. speed, voltage, current and/or power sensors. The angle sensor 710 reads an angle 714 from the electric motor 712 and sends the angle 714 to the machine control system 10. Furthermore, a torque 720 is detected, which is calculated, for example, from the phase currents of the electric motor 712 by means of the inverter 716. The torque 720 is also sent to the machine control system 10.

In a differentiator 719, the angle 714 is differentiated, preferably differentiated twice, resulting in an angular acceleration 721 and an angular velocity 722. In principle, however, other measurement variables can also be obtained using the sensors. The angular acceleration 721 and the angular velocity 722 are sent together with the torque 720 to a parameter estimator 726 in the model-based axle monitoring system 20. The parameter estimator 726 estimates various model parameters with the aid of the above equations 7 and 8, preferably with the aid of at least one algorithm, e. g. an RLS algorithm. In the exemplary embodiment in FIG. 7, these are a moment of inertia 736, a damping 737 and/or a disturbance torque 738. In a further preferred exemplary embodiment, an uncertainty of these model parameters is also determined, wherein the estimated model parameters are only used if the parameter uncertainty is small enough.

With the estimated model parameters (in the exemplary embodiment in FIG. 7: the moment of inertia 736, the damping 737 and/or the disturbance torque 738), a simulated torque 731 is determined in a simulation 728, e.g. a dynamics simulation, which is compared with the (measured) torque 720 in a check 730, e.g. a threshold value check. If the torque 720 and simulated torque 731 deviate too far from each other, a signal 732, e.g. an alarm signal, is sent to a path planning CNC 734 of the machine control system 10, which sends, for example, a target angle 735 to the inverter 716 in order to slow down or stop the axle 10, for example.

It is understood that this description may be subject to various modifications, changes and adaptations which are within the scope of equivalents to the appended claims.

1. A method for detecting an error in the actual position of an axle of a machine for at least one of handling or processing plastifiable materials, said method comprising the following steps:
providing a model of the axle, comprising at least one model parameter,
detecting at least one model input measurement variable and at least one model output measurement variable of the axle,
estimating the at least one model parameter of the model,
simulating at least one expected measurement variable by means of the estimated model parameter of the model and the detected at least one model input measurement variable,
comparing the deviation of the expected measurement variable from the detected at least one model output measurement variable with at least one threshold, and
if the threshold is exceeded, carrying out at least one action.

2. A method in accordance with claim 1, wherein the at least one model input measurement variable differs from the at least one model output measurement variable.

3. A method in accordance with claim 1, wherein, for the detection of at least one of the model input measurement variable or the model output measurement variable, at least one signal portion of the at least one of the model input measurement variable or the model output measurement variable is detected.

4. A method in accordance with claim 1, wherein at least one mathematical operation is used to generate at least one other signal portion of the at least one of the model input measurement variable or the model output measurement variable.

5. A method in accordance with claim 1, wherein at least one adjustment is made to least one of the model or the model parameter.

6. A method in accordance with claim 1, wherein the model is linearly dependent on the model parameter.

7. A method in accordance with claim 1, wherein, if the at least one threshold is exceeded, at least one diagnostic file is generated.

8. A method in accordance with claim 1, wherein at least one instance of a critical axle speed of the axle being exceeded is checked.

9. A method in accordance with claim 1, wherein at least one model certainty of the at least one model of the axle is checked.

10. A method in accordance with claim 9, wherein the checking of the at least one model certainty is performed on the basis of the determination of the eigenvalues of a covariance matrix.

11. A method in accordance with claim 1, wherein it is checked whether the estimation of the at least one model parameter was active at least for a critical time.

12. A method in accordance with claim 1, wherein at least one of the model or the at least one model parameter is adjusted to at least one ambient condition.

13. A method in accordance with claim 5, wherein the at least one of the adjustment of the model or the adjustment of the at least one model parameter takes place more slowly than the error detection.

14. A method in accordance with claim 1, wherein the estimation of the at least one model parameter is carried out recursively.

15. Method in accordance with claim 1, wherein a recursive least squares algorithm is used for the estimation of the at least one model parameter.

16. Method in accordance with claim 1, wherein at least one of the model input measurement variable or the at least one model output measurement variable is used for the estimation of the at least one model parameter.

17. Method in accordance with claim 1, wherein the machine for at least one of handling or processing plastifiable materials is an injection moulding machine or a forming machine.

18. An error detection device, set up, configured and/or constructed to carry out the method in accordance with claim 1.

19. A computer program product with a program code that is stored on a computer-readable medium for carrying out the method in accordance with the claim 1.
